(19) United States
(12) Patent Application Publication
(10) Pub. No.: US 2006/0008666 A1
(43) Pub. Date: Jan. 12, 2006

(54) Heat shrinkable film using a blend of polypropylene impact copolymer, syndiotactic polypropylene and/or polypropylene random copolymer

(76) Inventors: Mark B. Miller, Houston, TX (US); Juan Jose Aguirre, League City, TX (US)

Correspondence Address: FINA TECHNOLOGY INC, PO BOX 674412, HOUSTON, TX, 77267-4412, US

(21) Appl. No.: 10/885,439

(22) Filed: Jul. 6, 2004

(51) Int. Cl. B32B 27/32; C08L 23/00

(52) U.S. Cl. 428/523; 525/240

(57) ABSTRACT

It has been discovered that the properties of heat shrinkable sheet or film materials of ethylene/propylene rubber impact-modified heterophasic copolymer (ICP) can be improved by blending the ICP with a second polyolefin. The second polyolefin may be a syndiotactic polypropylene (sPP), a random copolymer (RCP) of propylene and a comonomer (e.g. ethylene and/or butene) made using a Ziegler-Natta or metallocene catalyst. A cavitating agent may be optionally included. The heat shrinkable sheet or film materials may also be biaxially oriented. Property differences in films made with the inclusion of the second polyolefin and possibly the cavitating agent include, but are not necessarily limited to, reduction in yield stress, increased density, decreased cavitation, increased light transmittance, increased shrinkage, among other physical and mechanical properties.

### FIELD OF THE INVENTION

The present invention is related to methods and compositions useful to improve the manufacture of heat shrinkable sheets or films containing polypropylene. It relates more particularly to methods for making blends of impact copolymers with other polymers or copolymers to improve the characteristics thereof, as well as the resulting film and sheet materials per se.

### BACKGROUND OF THE INVENTION

Polyolefins and polyvinyl chlorides are the two major families of synthetic resins from which most of the commercially available heat shrinkable films for wrapping purposes are manufactured. Other synthetic resins which are useful for the fabrication of heat shrinkable films include various ionomers, polyesters, polystyrenes and polyvinylidene chlorides. The shrinkable polyolefins currently on the market are for the most part monolayer films, which include both crosslinked and uncrosslinked oriented polyethylene, oriented polypropylene, and oriented ethylene-propylene copolymers and particularly biaxially oriented ethylene-propylene copolymers.

A heat shrinkable film's unique property is its ability upon exposure to some level of heat to shrink (reduce its physical dimensions) or, if restrained, to create shrink tension within the film. This ability is activated by the packager when the wrapped product is exposed to heat, such as passing through a hot air shrink tunnel or hot water bath. The resulting shrinkage of the film results in an attractive and functional transparent wrapping which conforms to the contour of the product while providing the usual functions required of packaging materials such as protection of the product from loss of components, pilferage, contamination, spoilage or damage due to handling and shipment. Typical items or articles wrapped in PVC or polyolefin heat shrinkable films include, but are not necessarily limited to, foods, toys, games, hardware and household products, sporting goods, stationery, greeting cards, office supplies, and industrial parts.

The manufacture of heat shrinkable films requires the use of complex and sophisticated equipment including, but not necessarily limited to, extrusion lines, irradiation units when cross-linking is desired, tenter frame, double-bubble, and slitters. Double-bubble and tenter framing are conventional orientation processes which cause the film to be stretched in the longitudinal or machine direction and in the cross or transverse direction, sequentially or simultaneously. The films are usually heated to their orientation temperature range, which varies with different polymers but is usually above room temperature and below the polymer's melting temperature. After being stretched, the film is cooled to quench it thus freezing the molecules of the film in their oriented state. Upon heating, the orientation stresses are relaxed and the film will begin to shrink back to its original, unoriented dimension.

Heat shrinkable films are known in the art to be obtained by blending some polypropylene homopolymers with particular random copolymers or butene copolymers.

Notwithstanding the good results brought about by the techniques and materials already known, it would be desirable if methods could be devised or discovered to provide polypropylene film or sheet materials having improved mechanical and optical properties, particularly in the packaging sector.

### SUMMARY OF THE INVENTION

There is provided, in one form, a heat shrinkable film or sheet material that includes at least one ethylene/propylene rubber impact-modified heterophasic copolymer (ICP), and from about 5 to about 95 wt % of at least one second polyolefin. The second polyolefin may be a syndiotactic polypropylene (sPP) and/or a random copolymer (RCP) of propylene and a comonomer, where the comonomer may be ethylene and/or butene. The RCP may be made using a Ziegler-Natta catalyst (ZNRCP), a metallocene catalyst (mRCP) or other polymerization catalyst.

In another embodiment of the invention, there is provided an impact copolymer resin blend that has at least one ICP as defined above and from about 5 to about 95 wt % of at least one second polyolefin. Again, the second polyolefin may be a sPP and/or a RCP of propylene and a comonomer, where the comonomer may be ethylene and/or butene. The RCP may be a ZNRCP and/or a mRCP.

In yet another embodiment of the invention there is provided a process for making a heat shrinkable film or sheet material that involves blending at least one ICP as defined above with from about 5 to about 95 wt % of at least one second polyolefin. The second polyolefin may be a sPP and/or a RCP of propylene and comonomer, where again the comonomer may be ethylene and/or butene. Again, the RCP may be a ZNRCP and/or a mRCP. The polymer blend is fed to an extruder, and the polymer blend is extruded through a die to form a film or sheet material.

### BRIEF DESCRIPTION OF THE DRAWINGS

FIG. 1 is a graph of the effect of draw temperature on yield stress for oriented opaque films using different formulations as well as an unblended ICP film;

FIG. 2 is chart of film shrinkage performed at 180 seconds and 125° C. for the films from the blend formulations and a reference ICP film;

FIG. 3 is a chart of film shrinkage performed at 180 seconds and 140° C. for the films from the blend formulations and the reference ICP film; and

FIG. 4 is a chart of film shrinkage performed at 180 seconds and 125° C. for the films from the blend formulations and the reference ICP film where all the films were selected at the temperature where the yield stress is 2.8 MPa.

### DETAILED DESCRIPTION OF THE INVENTION

It has been discovered that ethylene/propylene rubber impact-modified heterophasic copolymers (ICPS) such as ATOFINA's 4320 polypropylene can be advantageously blended with other polyolefins to give heat shrinkable films and sheet materials having improved or modified properties. Several different blends involving 4320 polypropylene mixed with other, second polyolefins include, but are not necessarily limited to, syndiotactic polypropylene (sPP), metallocene random copolymers, Ziegler-Natta random copolymers, etc. that improve or change properties including, but not necessarily limited to, reduction in yield stress, increased shrinkage and other improved physical and mechanical properties. A cavitating agent may be optionally included.

The ethylene/propylene rubber impact-modified heterophasic copolymer (ICP) that is modified with a second polyolefin in the context of this invention may be one having a polydispersity from about 4 to about 15, and a melt flow rate from about 0.7 to about 20 g/10 min. Impact copolymers falling within this definition include, but are not necessarily limited to ATOFINA's 4320 polypropylene, ATOFINA 4520 polypropylene, ATOFINA 4170 and ATOFINA 4280 polypropylene. In one non-limiting embodiment of the invention, the ICP may have a polydispersity from about 4 to about 12, a melt flow rate from about 1.3 to about 5 g/10 min. Methods for making ICPs are well known in the art, for instance, in one non-limiting embodiment methods and techniques as described in U.S. Pat. No. 6,657,024, incorporated herein by reference, may be used.

The impact copolymer may be blended with from about 5 to about 95 wt % of a second polyolefin, and in another non-limiting embodiment is blended with about 10 to about 50 wt % of the second polyolefin. In an alternate non-limiting embodiment, from about 10 to about 25 wt % of the second polyolefin is used. All of these proportions are based on the total amount of the overall blend.

One of the polyolefins that can be advantageously blended with ICP is syndiotactic polypropylene or sPP. Syndiotactic polypropylene is a stereospecific polymer that has a defined arrangement of molecules in space. Syndiotactic propylene polymers are typically described as having the methyl groups attached to the tertiary carbon atoms of successive monomeric units on the alternating side of a hypothetical plane through the main chain of the polymer, e.g., the methyl groups alternate being above or below the plane. As noted previously, stereospecificity can be determined by the choice of external electron donor to the catalyst. Suitable sPPs for this invention are those having a melt flow rate from about 1.0 to about 100 g/10 min, a melting point of from about 90 to about 155° C. and xylene solubles of about 20% or less. In another non-limiting embodiment of the invention, the sPP has a melt flow rate from about 1.3 to about 20 g/10 min, a melting point of about 110 to about 140° C. and xylene solubles from about 2 to about 15.

Another polyolefin useful for blending with ICP are random copolymers (RCPs) of propylene and a comonomer selected from the group consisting of ethylene, butene, hexene, octene and larger α-olefins that are polymerized with propylene using Ziegler-Natta or metallocene catalysts. The Ziegler-Natta catalysts may typically be those already described. With respect to the metallocene random copolymers, this term denotes polymers obtained by copolymerizing ethylene and an α-olefin, such as propylene, butene, hexene or octene, in the presence of a monosite catalyst generally consisting of an atom of a metal which may, for example, be zirconium or titanium, and of two cyclic alkyl molecules bonded to the metal. More specifically, the metallocene catalysts are usually composed of two cyclopentadiene-type rings bonded to the metal. These catalysts are often used with aluminoxanes as cocatalysts or activators, preferably methylaluminoxane (MAO). Hafnium may also be used as a metal to which the cyclopentadiene is bound. Other metallocenes may include transition metals of groups IV A, V A and VI A. Metals of the lanthanide series may also be used. These metallocene RCPs may also be characterized by their M_{w}/Mₙ ratio of <4 in one non-limiting embodiment, alternatively <3.

In one non-limiting embodiment of the invention, the RCP used in the blends herein has a melt flow rate of from about 0.7 to about 50 g/10 min, a melting point of from about 90 to about 158° C. and xylene solubles of about 13% or less. In another non-limiting embodiment, the RCP may have a melt flow rate of from about 4 to about 30 g/10 min, a melting point of from about 105 to about 138° C. and xylene solubles from about 0.05 to about 12%.

The blends of the present invention may be prepared using technologies known in the art, such as the mechanical mixing of the polyolefins using high-shear internal mixers of the Banbury type, or by mixing directly in the extruder. Although special blending equipment and techniques are acceptable within the scope of this invention, in one non-limiting embodiment the blends are made using the conventional extruders associated with heat shrinkable film production lines.

The blends of the present invention may also contain various additives capable of imparting specific properties to the articles the blends are intended to produce. Additives known to those skilled in the art that may be used in these blends include, but are not necessarily limited to, fillers such as talc, pigments, antioxidants, stabilizers, anti-corrosion agents, slip agents, and antiblock agents, etc. A particularly useful additive in the context of this invention is a cavitating agent. The particles cause plastic deformation, which produces cavitation and whitening or opacity.

The use of a cavitating agent in the core layer offers good opacity, which reduces the need for a heavy opacifying coating and thus reduces the weight of the film or sheet. The cavitating agent is present in an amount ranging from about 10 to about 40 wt % in one non-limiting embodiment. In an alternate non-limiting embodiment of the invention, the cavitating agent is present in an amount ranging from about 15 to about 30 wt %. Suitable cavitating agents include, but are not necessarily limited to, calcium carbonate, titanium dioxide, polybutylene terephthalate, and mixtures thereof.

The invention will now be described further with respect to actual Examples that are intended simply to further illustrate the invention and not to limit it in any way.

A study was performed on a Brückner Karo IV laboratory orienter to see the influence that different blends of impact copolymer polypropylene with different lower melting point materials have on film heat shrinkage properties.

Formulations are shown in Table I. The formulations consisted of a blend of ATOFINA 4320 polypropylene (impact copolymer) with syndiotactic polypropylene or random copolymer (metallocene or Ziegler-Natta type). The syndiotactic polypropylene used was FINAPLAS 1471 polypropylene. The Ziegler-Natta-catalyzed random copolymer was EOD 94-21 available from ATOFINA Petro-chemical, Inc. The metallocene-catalyzed random copolymer was a proprietary ATOFINA Petrochemical copolymer designated mRCP-1 herein. The same cavitating agent (A. Schulman PF61V) was used in all formulations: mineral filler and white pigment. Quality control data is also presented for each material.

TABLE I
Formulations Used and Quality Control Data for the
Resins Used to Produce Heat Shrinkable Opaque Films

| | Formula 1 | | Formula 2 | | Formula 3 | |
|---|---|---|---|---|---|---|
| Label | ICP + mRCP | | ICP + ZNRCP | | ICP + sPP | |
| Materials: | 4320 | 45% | 4320 | 45% | 4320 | 45% |
| | mRCP-1 | 25% | EOD94-21 | 25% | Finaplas 1471 | 25% |
| | A. Schulman | 30% | A. Schulman | 30% | A. Schulman | 30% |
| | PF61V | | PF61V | | PF61V | |

| | | | | Finaplas | A. Schulman |
|---|---|---|---|---|---|
| Resins | 4320 | mRCP-1 | EOD94-21 | 1471 | PF61V |
| HB | 65046 | 61262 | 67586 | 73975 | W12496 |
| MFR (g/10 min) | 3 | 7 | 10 | 5 | 3 |
| Xyl. Sol, % | 1.5 | 2.0 | 9.6 | 3.4 | N/A |
| Ethylene, % | 10 | 5* | 7.0 | 0.0 | N/A |
| *from R&D | | | | | |
| m.p., % | 160 | 123 | 123 | 129 | 160 |

Cast sheets of 980 microns (39 mils) were extruded on a laboratory sheet line (Welex 1.25″ (3.2 cm) extruder, 10″ (25.4 cm) die). Samples were oriented on the Brückner orienter at a ratio of 5×8, simultaneously. Machine direction orientation speed was 30 m/min, transverse direction orientation speed was 3 m/min at different stretching temperatures (from 135-155° C.).

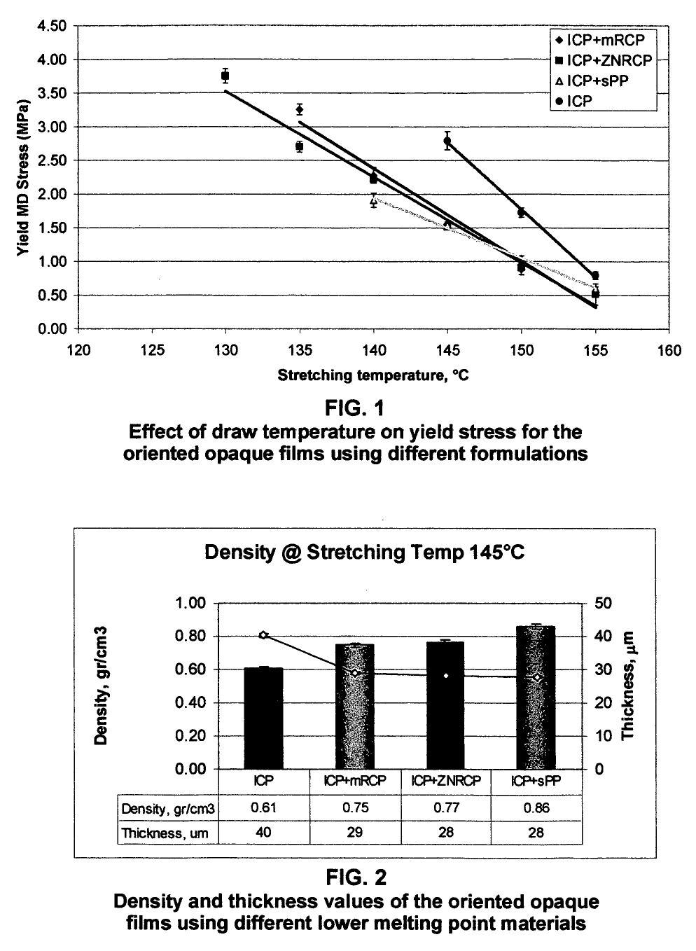

FIG. 1 illustrates the orientation properties of the different formulations. It can be observed that blends with random copolymers or syndiotactic material improve the processing window compared with the pure impact copolymer. A downward shift of the yield stress versus temperature line was observed with the blends of this invention. The broadest processing window was obtained with the blend of impact copolymer with conventional random copolymer (ICP+ZNRCP, Formula 2).

The films from the blends were expected to have a significant amount of shrinkage because of the low melting point materials used; however the results in FIG. 2 did not show this difference. It should be noted that the shrinkage conditions were performed at 125° C. for 180 seconds. Modifications to the standard conditions were made in order to see if there was a better way to differentiate the films. Two approaches were followed: 1) Perform shrinkage at higher temperatures (140° C.) for the same time (180 sec.); and 2) Perform shrinkage at constant yield stress (example: 2.8 MPa) and use standard conditions.

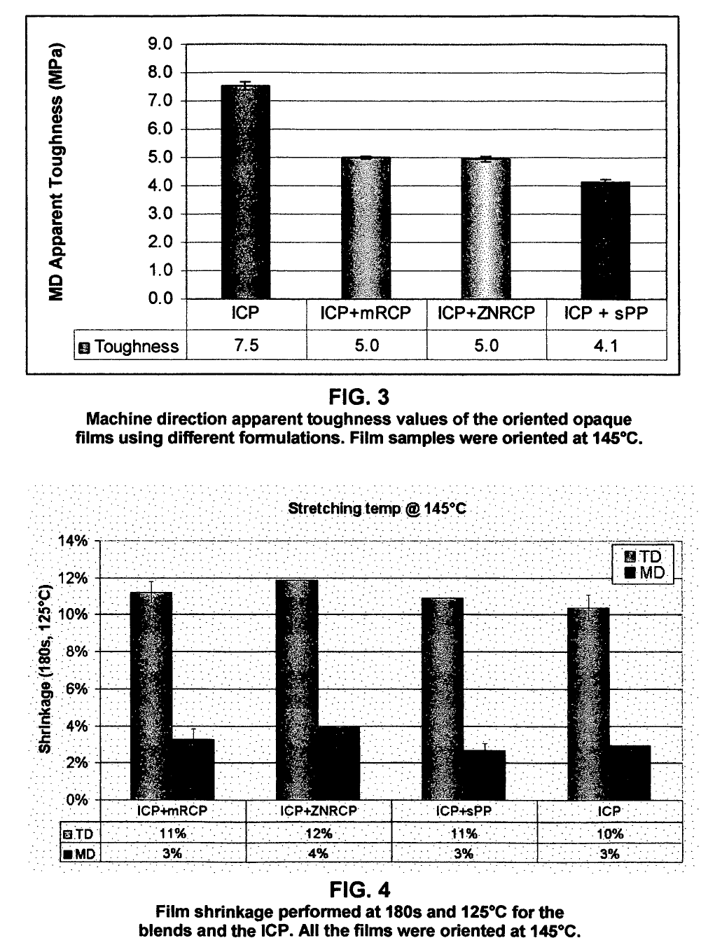

FIG. 3 shows that differences in shrinkage values were observed between the pure impact copolymer and the different blends in the transverse direction (TD). In this evaluation the conditions used were at 140° C. for 180 seconds. With the higher oven temperature in the shrinkage test, the differences can be appreciated more clearly. In general, it may be observed that random copolymers (ZN or metallocenes) or syndiotactic material blends used in this study provide films with a higher shrinkage in TD compared to pure impact copolymer. Also, no noticeable differences among the blends can be observed.

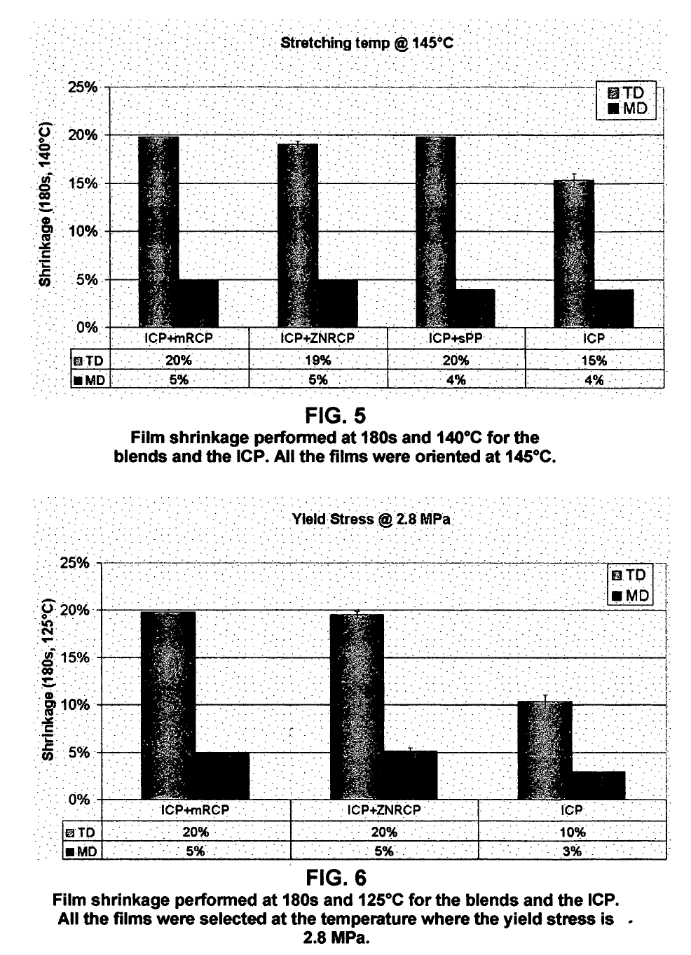

By performing the other approach (at a constant yield stress of 2.8 MPa) using standard shrinkage conditions, differences are also noticed even more clearly between pure impact copolymer and the blends. The results in FIG. 4 show that the blends presented higher shrinkage in machine and transverse direction as contrasted with the pure impact copolymer. No differences were observed between metallocene and Ziegler-Natta technology. In the FIG. 4 testing, film shrinkage was performed at 125° C. for 180 seconds and for the blends and the ICP. As noted, all of the films were selected at the temperature where the yield stress was 2.8 MPa. However, the blend of ICP+sPP (Formula 3) was not included since this blend reached a yield stress lower than 2.8 mPa.

TABLE II
Optical and Mechanical Property Results for ICP and the Blends

| | | Formula | | | |
|---|---|---|---|---|---|
| | | | 1 | 2 | 3 |
| | | | ICP + | ICP + | ICP + |
| Property | Units | ICP | mRCP | ZNRCP | sPP |
| Optical Properties | | | | | |
| Light transmittance | % | 27 | 51 | 51 | 58 |
| Gloss @ 45° | % | 17 | 14 | 12 | 14 |
| Mechanical Properties | | | | | |
| 1% Secant Mod MD | MPa | 590 | 800 | 750 | 770 |
| 1% Secant Mod TD | MPa | 1300 | 1480 | 1400 | 1350 |
| Tensile @ Break MD | MPa | 55 | 60 | 60 | 60 |
| Tensile @ Break TD | MPa | 110 | 125 | 125 | 90 |
| Elong. @ Break MD | % | 70 | 110 | 120 | 110 |
| Elong. @ Break TD | % | 20 | 30 | 35 | 30 |
| Shrinkage MD @ | % | 4 | 5 | 5 | 4 |
| 140° C., 180 seconds | | | | | |
| Shrinkage TD @ | % | 15 | 20 | 19 | 20 |
| 140° C., 180 seconds | | | | | |

Film property characterizations are shown in Table II. The results show that all of the blends offer similar mechanical properties. 4320 (ICP) forms the softest film for the machine direction.

In the foregoing specification, the invention has been described with reference to specific embodiments thereof, and has been demonstrated as effective in providing methods for preparing heat shrinkable films having improved and altered properties. However, it will be evident that various modifications and changes can be made thereto without departing from the scope of the invention as set forth in the appended claims. Accordingly, the specification is to be regarded in an illustrative rather than a restrictive sense. For example, specific combinations or proportions of polymers and other components falling within the claimed parameters, but not specifically identified or tried in a particular polymer blend formulation, are anticipated and expected to be within the scope of this invention. Further, the methods of the invention are expected to work at other conditions, particularly extrusion conditions, than those exemplified herein. For instance, the resin blends of this invention may be co-extruded with films or sheet materials of other resins and adhered together to form a multilayer sheet or film material. Furthermore, it is within the scope of this invention to provide articles or items wrapped or covered with the single layer or multilayer heat shrinkable film or sheet materials of this invention.

TABLE III
ASTM Film Test Methods Used in this Invention

| Property | ASTM Procedure |
|---|---|
| Tensile Strength, Elongation, Modulus | D882 |
| Dimensional Stability | D1204 |
| Gloss | D2457 |
| (value is unitless, based on the gloss scale) | |
| Light Transmission | D1003 |

GLOSSARY

| | |
|---|---|
| 1471 | FINAPLAS ® 1471 metallocene syndiotactic |
| | propylene polymer (sPP) having the |
| | characteristics noted in Table I, available |
| | from ATOFINA Petrochemicals Inc. |
| 4320 | ATOFINA ® PP 4320 polypropylene; a fractional |
| | melt flow impact copolymer (ICP) produced with |
| | a Ziegler-Natta catalyst, available from ATOFINA |
| | Petrochemicals Inc. |
| EOD 94-21 | A Ziegler-Natta random copolymer (RCP) having |
| | the characteristics noted in Table I, available |
| | from ATOFINA Petrochemicals Inc. |
| mRCP-1 | A proprietary metallocene RCP having the |
| | characteristics noted in Table I. |
| PF61V | A mineral filled-white pigment cavitating |
| | agent available from A. Schulman Inc. |

What is claimed is:

1. A heat shrinkable film or sheet material comprising a blend of:
at least one ethylene/propylene rubber impact-modified heterophasic copolymer (ICP), and
from about 5 to about 95 wt % of at least one second polyolefin, where the second polyolefin is selected from the group consisting of
a syndiotactic polypropylene (sPP), and
a random copolymer (RCP) of propylene and a comonomer selected from the group consisting of ethylene and butene, where the RCP is made using a Ziegler-Natta catalyst (ZNRCP) or a metallocene catalyst (mRCP).

2. The film or sheet material of claim 1 where the ICP has a polydispersity from about 4 to about 15 and a melt flow rate from about 0.7 to about 20 g/10 min.

3. The film or sheet material of claim 1 where the sPP has a melt flow rate from about 1 to about 100 g/10 min., a melting point from about 90 to about 155° C. and xylene solubles of about 20% or less.

4. The film or sheet material of claim 1 where the RCP has a melt flow rate from about 0.7 to about 50 g/10 min., a melting point from about 90 to about 158° C. and xylene solubles of about 13% or less.

5. The film or sheet material of claim 1 where the second polyolefin is present in an amount from about 10 to 40 wt %.

6. The film or sheet material of claim 1 further comprising a cavitating agent.

7. The film or sheet material of claim 6 where the cavitating agent is selected from the group consisting of calcium carbonate, titanium dioxide, polybutylene terephthalate, and mixtures thereof.

8. The film or sheet material of claim 6 where the cavitating agent is present in an amount ranging from about 10 to about 40 wt %.

9. The film or sheet material of claim 1 where the material has a reduction in yield stress as compared with an identical material absent the second polyolefin.

10. The film or sheet material of claim 6 where the material is biaxially oriented and has an increased density, decreased cavitation and increased light transmittance as compared with an identical material absent the second polyolefin.

11. The film or sheet material of claim 1 where the material has increased shrinkage as compared with an identical material absent the second polyolefin.

12. A heat shrinkable film or sheet material comprising a blend of:
at least one ethylene/propylene rubber impact-modified heterophasic copolymer (ICP) having a polydispersity from about 4 to about 15 and a melt flow rate from about 0.7 to about 20 g/10 min. and
from about 5 to about 95 wt % of at least one second polyolefin, where the second polyolefin is selected from the group consisting of
a syndiotactic polypropylene (sPP) having a melt flow rate from about 1 to about 100 g/10 min., a melting point from about 90 to about 155° C. and xylene solubles of about 20% or less, and
a random copolymer (RCP) of propylene and a comonomer selected from the group consisting of ethylene and butene having a melt flow rate from about 2 to about 50 g/10 min., a melting point from about 90 to about 158° C. and xylene solubles of about 13% or less, where the RCP is made using a Ziegler-Natta catalyst (ZNRCP) or a metallocene catalyst (mRCP).

13. The film or sheet material of claim 12 where the second polyolefin is present in an amount from about 10 to 40 wt %.

14. The film or sheet material of claim 12 further comprising a cavitating agent selected from the group consisting of calcium carbonate, titanium dioxide, polybutylene terephthalate, and mixtures thereof.

15. The film or sheet material of claim 14 where the cavitating agent is present in an amount ranging from about 10 to about 40 wt %.

16. The film or sheet material of claim 12 where the material has a reduction in yield stress as compared with an identical material absent the second polyolefin.

17. The film or sheet material of claim 14 where the material is biaxially oriented and has an increased density, decreased cavitation and increased light transmittance as compared with an identical material absent the second polyolefin.

18. The film or sheet material of claim 12 where the material has increased shrinkage as compared with an identical material absent the second polyolefin.

19. An article wrapped in the film or sheet material of claim 12.

20. An impact copolymer resin blend comprising:
at least one ethylene/propylene rubber impact-modified heterophasic copolymer (ICP), and
from about 5 to about 90 wt % of at least one second polyolefin, where the second polyolefin is selected from the group consisting of
a syndiotactic polypropylene (sPP), and
a random copolymer (RCP) of propylene and a comonomer selected from the group consisting of ethylene and butene, where the RCP is made using a Ziegler-Natta catalyst (ZNRCP) or a metallocene catalyst (mRCP).

21. The impact copolymer resin blend of claim 20 where the ICP has a polydispersity from about 4 to about 15 and a melt flow rate from about 0.7 to about 20 g/10 min.

22. The impact copolymer resin blend of claim 20 where the sPP has a melt flow rate from about 1 to about 100 g/10 min., a melting point from about 90 to about 155° C. and xylene solubles of about 20% or less.

23. The impact copolymer resin blend of claim 20 where the RCP has a melt flow rate from about 0.7 to about 50 g/10 min., a melting point from about 90 to about 158° C. and xylene solubles of about 13% or less.

24. The impact copolymer resin blend of claim 20 where the second polyolefin is present in an amount from about 10 to 40 wt %.

25. The impact copolymer resin blend of claim 20 further comprising a cavitating agent.

26. The impact copolymer resin blend of claim 25 where the cavitating agent is selected from the group consisting of calcium carbonate, titanium dioxide, polybutylene terephthalate, and mixtures thereof.

27. The impact copolymer resin blend of claim 25 where the cavitating agent is present in an amount ranging from about 10 to about 40 wt %.

28. An impact copolymer resin blend comprising:
at least one ethylene/propylene rubber impact-modified heterophasic copolymer (ICP) having a polydispersity from about 4 to about 15 and a melt flow rate from about 0.7 to about 20 g/10 min., and
from about 5 to about 90 wt % of at least one second polyolefin, where the second polyolefin is selected from the group consisting of
a syndiotactic polypropylene (sPP) having a melt flow rate from about 1 to about 100 g/l0 min., a melting point from about 90 to about 155° C. and xylene solubles of about 20% or less, and
a random copolymer (RCP) of propylene and a comonomer selected from the group consisting of ethylene and butene having a melt flow rate from about 2 to about 50 g/10 min., a melting point from about 90 to about 158° C. and xylene solubles of about 13% or less, where the RCP is made using a Ziegler-Nafta catalyst (ZNRCP) or a metallocene catalyst (mRCP).

29. The impact copolymer resin blend of claim 28 where the second polyolefin is present in an amount from about 10 to 40 wt %.

30. The impact copolymer resin blend of claim 28 further comprising a cavitating agent selected from the group consisting of calcium carbonate, titanium dioxide, polybutylene terephthalate, and mixtures thereof.

31. The impact copolymer resin blend of claim 30 where the cavitating agent is present in an amount ranging from about 10 to about 40 wt %.

32. A process for making a heat shrinkable film or sheet material comprising:
blending at least one ethylene/propylene rubber impact-modified heterophasic copolymer (ICP) with from about 5 to about 90 wt % of at least one second polyolefin, where the second polyolefin is selected from the group consisting of a syndiotactic polypropylene (sPP) and a random copolymer (RCP) of propylene and a comonomer selected from the group consisting of ethylene and butene, where the RCP is made using a Ziegler-Natta catalyst (ZNRCP) or a metallocene catalyst (mRCP);
feeding the polymer blend to an extruder; and
extruding the polymer blend through a die to form a film or sheet material.

33. The process of claim 32 where the ICP has a polydispersity from about 4 to about 15 and a melt flow rate from about 0.7 to about 20 g/10 min.

34. The process of claim 32 where the sPP has a melt flow rate from about 1 to about 100 g/10 min., a melting point from about 90 to about 155° C. and xylene solubles of about 20% or less.

35. The process of claim 32 where the RCP has a melt flow rate from about 0.7 to about 50 g/10 min., a melting point from about 90 to about 158° C. and xylene solubles of about 13% or less.

36. The process of claim 32 where the second polyolefin is present in an amount from about 10 to 40 wt %.

37. The process of claim 32 further comprising blending a cavitating agent with the ICP.

38. The process of claim 37 where the cavitating agent is selected from the group consisting of calcium carbonate, titanium dioxide, polybutylene terephthalate, and mixtures thereof.

39. The process of claim 37 where the cavitating agent is present in an amount ranging from about 10 to about 40 wt %.

40. A process for making a heat shrinkable film or sheet material comprising:
blending at least one ethylene/propylene rubber impact-modified heterophasic copolymer (ICP) having a polydispersity from about 4 to about 15 and a melt flow rate from about 0.7 to about 20 g/l0 min., with from about 5 to about 90 wt % of at least one second polyolefin, where the second polyolefin is selected from the group consisting of a syndiotactic polypropylene (sPP) having a melt flow rate from about 1 to about 100 g/10 min., a melting point from about 90 to about 155° C. and xylene solubles of about 20% or less and a random copolymer (RCP) of propylene and a comonomer selected from the group consisting of ethylene and butene, where the RCP is made using a Ziegler-Natta catalyst (ZNRCP) or a metallocene catalyst (mRCP), where the RCP has a melt flow rate from about 2 to about 50 g/10 min., a melting point from about 90 to about 158° C. and xylene solubles of about 13% or less;
feeding the polymer blend to an extruder; and
extruding the polymer blend through a die to form a film or sheet material.

41. The process of claim 40 where the second polyolefin is present in an amount from about 10 to 40 wt %.

42. The process of claim 40 further comprising blending a cavitating agent with the ICP, where the cavitating agent is selected from the group consisting of calcium carbonate, titanium dioxide, polybutylene terephthalate, and mixtures thereof.

43. The process of claim 42 where the cavitating agent is present in an amount ranging from about 10 to about 40 wt %.

44. A process for making a multilayer film or sheet material comprising co-extruding at least two resins together where at least one of the resins is a resin blend comprising:
at least one ethylene/propylene rubber impact-modified heterophasic copolymer (ICP), and
from about 5 to about 95 wt % of at least one second polyolefin, where the second polyolefin is selected from the group consisting of
a syndiotactic polypropylene (sPP), and
a random copolymer (RCP) of propylene and a comonomer selected from the group consisting of ethylene and butene, where the RCP is made using a Ziegler-Natta catalyst (ZNRCP) or a metallocene catalyst (mRCP).

45. A co-extruded, multilayer film or sheet material made by the process of claim 44.

46. An article wrapped in the co-extruded, multilayer film or sheet material of claim 45.

47. A process for making a multilayer heat shrinkable film or sheet material comprising:
blending at least one ethylene/propylene rubber impact-modified heterophasic copolymer (ICP) with from about 5 to about 90 wt % of at least one second polyolefin, where the second polyolefin is selected from the group consisting of a syndiotactic polypropylene (sPP) and a random copolymer (RCP) of propylene and a comonomer selected from the group consisting of ethylene and butene, where the RCP is made using a Ziegler-Natta catalyst (ZNRCP) or a metallocene catalyst (mRCP);
feeding the polymer blend to an extruder;
extruding the polymer blend through a first die to form a first film or sheet material;
extruding a second polymer resin through a second die to form a second film or sheet material; and
adhering the first film or sheet material to a second film or sheet material.

48. A multilayer film or sheet material made by the process of claim 47.

49. An article wrapped in the multilayer film or sheet material of claim 48.
